(19) United States
(12) Patent Application Publication
(10) Pub. No.: US 2007/0254759 A1
(43) Pub. Date: Nov. 1, 2007

(54) Transmitting multi-row chain

(76) Inventor: Atsuhiro Tamiya, Osaka (JP)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/648,916

(22) Filed: Jan. 3, 2007

(30) Foreign Application Priority Data
Apr. 28, 2006 (JP) 2006-126526

(51) Int. Cl. F16G 13/02

(52) U.S. Cl. 474/230

(57) ABSTRACT

A transmitting multi-row chain in which the chain strength is high, the chain is lightweight, and the disassembly and assembly operation of the chain such as disconnecting and connecting of the chain and the like is simple. A transmitting multi-row chain has inner link units, each comprising a pair of right and left inner plates into which a pair of front and rear bushes is press-fitted. The inner link units are connected in rows to each other in large numbers in the longitudinal direction of the chain by connecting pins and the rows are disposed in parallel with each other through intermediate plates in a width direction of the chain. The connecting pins are press-fitted into outer plates disposed on the outermost sides in the width direction of the chain and are loosely fitted into pin holes of the intermediate plates. The intermediate plates are each formed in a plate height dimension smaller than the plate height dimension of each of the inner plate and the outer plate. The ends of the intermediate links are semi-circular with a bulge in the plate-shearing direction.

### FIELD OF INVENTION

The present invention relates to a transmitting multi-row chain in which inner link units each comprising a pair of right and left inner plates into which a pair of front and rear bushes are press-fitted. The units are disposed in parallel with each other through intermediate plates in a width direction of the chain.

### BACKGROUND OF THE INVENTION

In a transmitting mechanism having a large power transmission load it has been known to use a transmission chain with strength enhanced by the fact that a plurality of chains are disposed in parallel with each other in a width direction of the chain so as to be integrated or the like.

And as such a conventional strength-enhanced transmission chain a multi-row chain has been known in which inner link units each comprising a pair of right and left inner plates into which a pair of front and rear bushes are press-fitted are disposed in parallel with each other through intermediate plates in a width direction of the chain and said inner link units are connected to each other in large numbers in the longitudinal direction of the chain by connecting pins press-fitted into outer plates disposed on the outermost side in the width direction of the chain (see, for example, Japanese Laid-Open Patent Publication No. Hei 7-103288).

### SUMMARY OF THE INVENTION

In the above-mentioned multi-row chain, the chain strength is enhanced by press-fitting, so called, close fitting connecting pins into pin holes in the intermediate plates to incorporate them. However, there were problems in that when such a close fit between the intermediate plate and the connecting pin is adopted, the pin hole diameter in the intermediate plate and the pin diameter of the connecting pin must be worked with high precision during manufacturing of the chain and that even in the disassembling or assembling such as disconnecting or connecting a chain, the close fitting operation becomes troublesome and an excessive assembly effort is needed.

Further, since in the above-mentioned multi-row chain the intermediate plate has the same outer appearance as each of the inner plate and the outer plate, there was a problem in that the intermediate plate travels in an excessive frictional contact with the inner and outer plates as well as other members such as a chain guide and the like so that its slide resistance is increased and the operating noise is also increased.

Accordingly, the object of the present invention is to solve the above-mentioned prior art problems and to provide a transmitting multi-row chain in which the chain strength is high, the chain is lightweight, and the disassembly and assembly operation of the chain such as disconnecting and connecting of the chain and the like is simple.

The present invention solves the above-described problems by providing a transmitting multi-row chain in which inner link units each comprising a pair of right and left inner plates into which front and rear bushes are press-fitted. The units are disposed in parallel with each other through intermediate plates in a width direction of the chain and the inner link units are connected to each other in large numbers in the longitudinal direction of the chain by connecting pins press-fitted into outer plates disposed on the outermost sides in the width direction of the chain. The connecting pins are loosely fitted into pin holes of the intermediate plates, and the intermediate plates are each formed with a plate height dimension smaller than the height dimension of both the inner plate and outer plate.

When the intermediate plates are subject to plate shearing forces generated by tension in the generally longitudinal direction of the chain, the present invention configures the perimeter of the intermediate plate to include an arc-shaped bulged portion bulged in the plate shearing direction to beyond the virtually semi-circular perimeters of the front and rear ends.

Preferably the bushes each mount an outside roller and are hollow to pass the connecting pins.

The transmitting multi-row chain of the present invention has rows of inner link units each comprising a pair of right and left inner plates into which a pair of front and rear bushes is press-fitted. The rows are disposed in parallel with each other through intermediate plates in a width direction of the chain. The inner link units in the rows are connected to each other in large numbers in the longitudinal direction of the chain by connecting pins press-fitted into outer plates disposed on the outermost sides in the width direction of the chain, the connecting pins being loosely fitted into pin holes of said intermediate plates. Each connecting pin is loosely fitted, or so-called clearance fitted, into a pin hole of the intermediate plate during manufacturing the chain, avoiding the need that the pin hole diameter of the intermediate plate and the pin diameter of the connecting pin are worked with high precision, unlike a conventional closely fitted multi-row chain. Simple disassembly and assembly of the chain such as disconnection and connection of the chain and the like can be attained. Further, since the intermediate plates are each formed with a plate height dimension smaller than each of the inner plate and outer plate, when the chain is traveled on a chain guide (sandwiched from both sides), it stably travels at only a level of the inner plate and the structure can contribute to making the entire chain lightweight.

According to a preferred feature of the present invention, the intermediate plate includes an arc-shaped bulged portion bulged in a plate shearing direction, which is generated by tension in a generally longitudinal direction of the chain. The bulge extends beyond the periphery which includes a virtual tangent line or arc between a pair of front and rear semi-circular shaped plate perimeters. The additional height of the arc-shaped bulged portion enhances the tensile strength and elastic modulus of the intermediate plate in the longitudinal direction of the chain to suppress the plastic deformation of the intermediate plate in a shearing direction of the plate, and the strength of the entire chain can be increased. And since a load balance in the chain width direction with respect to tension in the longitudinal direction of the chain is improved, even if a large power transmission load is generated, fatigue resistance of the chain can be significantly improved.

A further feature is that the bushes each rotatably mount a roller outside. Since the rollers engage with a sprocket and smoothly roll during the engagement with sprocket, wear of the chain can be reduced.

### BRIEF DESCRIPTION OF THE DRAWINGS

FIG. 1 is an exploded perspective view of an assembly of a transmitting multi-row chain, which is one example of the present invention.

FIG. 2A is a plan view, partially in section, showing the transmitting multi-row chain that is one example of the present invention;

FIGS. 2B and 2C are enlarged partial cross-sections of areas encircled in FIG. 2A;

FIG. 3A is a side view of an intermediate plate used in this example;

FIG. 3B is a partial enlarged view of an area encircled in FIG. 3A;

FIG. 4 is a comparative view of outer appearances of an inner plate, an outer plate and an intermediate plate.

FIG. 5A is a view showing an example of a modified intermediate plate used in this example; and

FIG. 5B is an enlarged view of an area encircled in FIG. 5

### DESCRIPTION OF THE PREFERRED EMBODIMENTS

The drawings illustrate a transmitting multi-row chain in which there are rows of link units each comprising a pair of right and left inner plates into which a pair of front and rear bushes is press-fitted. The rows are disposed in parallel with each other through intermediate plates in a width direction of the chain. The inner link units in each row are connected to each other in large numbers in the longitudinal direction of the chain by connecting pins press-fitted into outer plates disposed on the outermost side in the width direction of the chain. The connecting pins are loosely fitted into pin holes of said intermediate plates, and the intermediate plates are each formed with a plate height dimension smaller than each of said inner and outer plates whereby the chain strength is high, the chain is lightweight and the disassembly and assembly operation of the chain such as disconnecting and connecting of the chain and the like becomes simple. Any concrete embodiment of the present invention may be used.

Various shapes of an inner plate, an outer plate and an intermediate plate may be used in a transmitting multi-row chain according to the present invention, for example, any shapes such as an oval type and a gourd type. Further, although the number of rows of inner link units disposed in parallel in a chain width direction in the transmitting multi-row chain according to the present invention is usually two or three, more than three rows may be used. Further, as objects of the transmitting multi-row chains of the present invention either of a bush chain and a roller chain may be adapted. In a roller chain, the rollers are usually mounted on bushes. The illustrated embodiments show rollers mounted on bushes. The bush chain is the most suitable for a case where it is used during power transmission where a power transmission speed is relatively low and a load applied to the chain is small. On the other hand, since the roller chain has smooth engagement with a sprocket, wear of the chain can be prevented when rollers are mounted on the bushes.

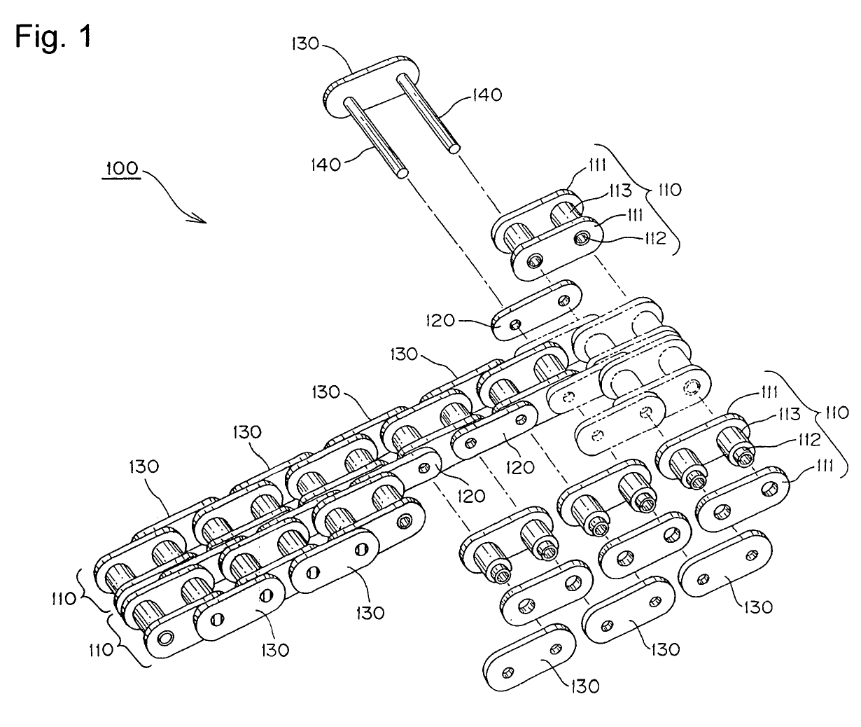

FIG. 1 illustrates a transmitting multi-row chain 100 that is one example of the present invention.

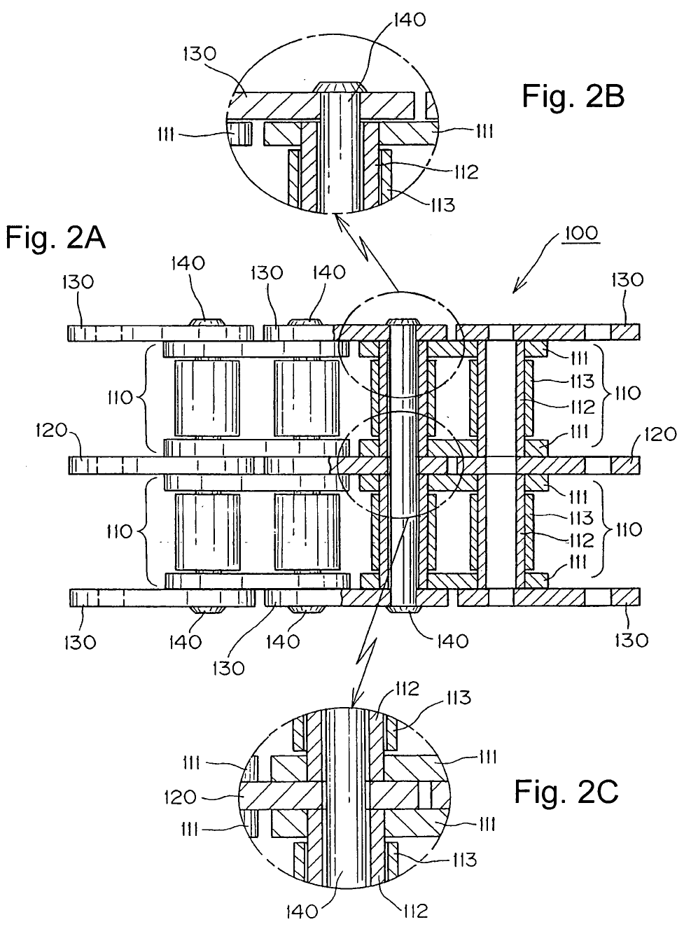

First, in the transmitting multi-row chain 100, as shown in FIGS. 1 and 2, two sets of inner link units each comprising a pair of right and left inner plates 111, 111 into which a pair of front and rear bushes 112, 112 is press-fitted are disposed in parallel with each other through intermediate plates 120 in a width direction of the chain. The inner link units 110 are connected to each other in large numbers in the longitudinal direction of the chain by connecting pins 140 press-fitted into outer plates 130 disposed on the outermost sides in the width direction of the chain.

It is noted that the inner plate 111, the intermediate plate 120 and the outer plate 130 each have an oval-type plate shape with semi-circular end peripheries and top and bottom edge peripheries extending tangentially between the end peripheries.

In the transmitting multi-row chain 100 a roller 113 is rotatably pivoted on the bush 112 of the above-mentioned inner link unit 110 so that the roller 113 is engaged with sprocket teeth while being rolled smoothly during the engagement with a sprocket (not shown). Thus the transmitting multi-row chain 100 forms a roller chain that prevents wear of the chain.

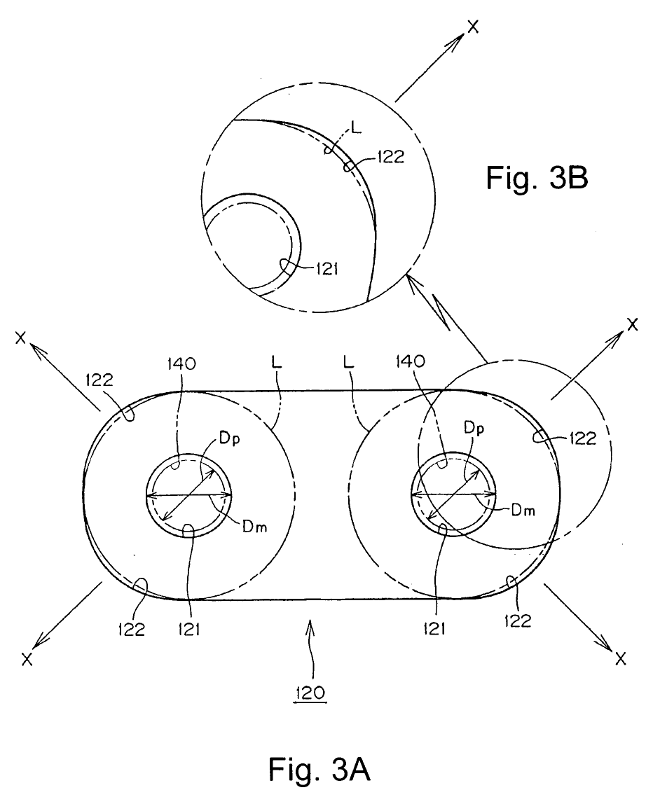

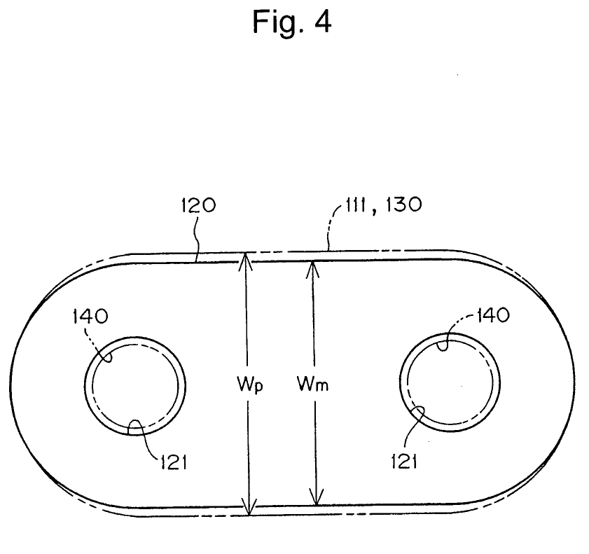

A concrete form of the intermediate plate 120, which is the most characteristic in the transmitting multi-row chain 100 in this example, will be described in more detail with reference to FIGS. 3A, 3B and 4.

First, as shown in FIG. 3A, the intermediate plate 120 has a pair of front and rear pin holes 121, 121 into which connecting pins 140 are loosely fitted. The connecting pins 140 are loosely fitted (so-called clearance-fitted) into the pin holes 121, 121 of the intermediate plate 120 during manufacturing the chain. As illustrated in FIG. 3A, a diameter Dm of the pin hole 121 in the intermediate plate 120 is formed in a larger size than a diameter Dp of the connecting pin 140 such that the connecting pin 140 can be clearance-fitted into the pin hole 121.

Since it is not necessary in the transmitting multi-row chain 100 in this example that the pin hole of the intermediate plate and the circumferential surface of the connecting pin are worked with high precision unlike a conventional closely fitted multi-row chain, disassembly and assembly of the chain such as disconnection and connection of the chain and the like can be attained easily.

Further, since the intermediate plates 120 are each formed in a plate height dimension Wm (FIG. 4) smaller than a plate width size Wp of each of the inner plate 111 and outer plate 130, when the chain is traveled on a chain guide (sandwiched from both sides), it stably travels at only a level of the inner plate 120 and the structure can contribute to making the entire chain lightweight.

Further, since the intermediate plate 120 includes, as shown in FIGS. 3A and 3B, an arc-shaped bulged portion 122 bulged in a plate shearing direction X, which is generated by tension in the longitudinal direction of the chain, beyond a virtually semi-circular pair of front and rear plate outer circumferences, the arc-shaped bulged portion 122 enhances the tensile strength and elastic modulus of the intermediate plate 120 in the generally longitudinal direction of the chain to suppress the plastic deformation of the intermediate plate 120 in a shearing direction X of the plate and the strength of the entire chain can be increased. And since a load balance in the chain width direction with respect to tension in the longitudinal direction of the chain is improved, even if a large power transmission load is generated, the fatigue resistance of the chain can be significantly improved.

Here in the case of this example, the above-described plate shearing direction X means a direction of about 45° from the center of the pin hole 121 in the intermediate plate 120. And the virtual arc line L is an arc line drawn by a diameter of the arc corresponding to a plate width size Wm.

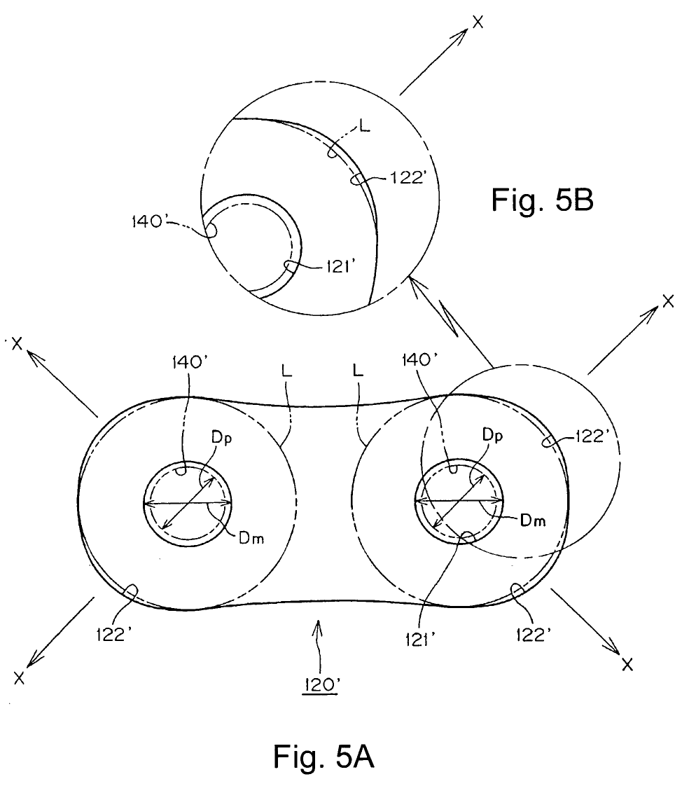

It is noted in this example the inner plate 111, the intermediate plate 120 and the outer plate 130 each have an oval type plate shape as described above. However, as shown in FIGS. 5A and 5B, each of these plates may take a gourd type plate shape, and a transmitting multi-row chain comprising the gourd type plate shaped plates can obtain the same effects as in the case of the transmitting multi-row chain 100 comprising the above-described oval type plate shaped inner plate 111, the intermediate plate 120 and the outer plate 130. In this embodiment, corresponding parts are designated with primed reference characters.

In the thus obtained transmitting multi-row chain of the present example since the connecting pin 140′ is loosely fitted into the pin hole 121′ of the intermediate plate 120′ and the intermediate plate 120′ is formed in a plate width size Wm smaller than the plate width size Wp of each of the inner plate 111 and the outer plate 130, a high strength of the chain is obtained, contact resistance to a chain guide and the like is suppressed and the disassembly and assembly operation such as disconnection and disconnection of the chain and the like can be simplified. Further, since the intermediate plate 120′ includes an arc-shaped bulged portion 122′ bulged in a plate shearing direction X, which is generated by tension in the longitudinal direction of the chain beyond a virtual circular arc line L defining a pair of front and rear generally semi-circular-shaped plate outer circumferences, the strength of the entire chain is increased. And since a load balance in the chain width direction with respect to tension in the generally longitudinal direction of the chain is improved, even if a large power transmission load is generated, the fatigue resistance of the chain can be significantly improved. Thus, the beneficial effects of the present invention are very large.

1. A transmitting multi-row chain having parallel inner link units and intermediate plates between said link units, each link unit comprising a pair of right and left inner plates and a pair of front and rear bushes press-fitted into said plates, said inner link units being disposed in parallel with each other through said intermediate plates in a width direction of the chain, said intermediate plates having pin holes,
said inner link units being connected to each other in large numbers in the longitudinal direction of the chain by outer plates having connecting pins press-fitted into said outer plates, said connecting plates being disposed on the outermost sides in the width direction of the chain,
said connecting pins being loosely fitted into said pin holes of said intermediate plates,
said inner and outer plates having heights transverse to the width direction of the chain, and.
said intermediate plates each having a plate height size smaller than each of said inner plate and outer plate.

2. A transmitting multi-row chain according to claim 1, wherein said chain has a plate shearing direction generated by tension in the generally longitudinal direction of the chain, and said intermediate plate has an outer periphery defined by front and rear semi-circular perimeters and tangential segments defining the height of the plates, and an arc-shaped bulged portion bulged in said plate-shearing direction beyond said periphery.

3. A transmitting multi-row chain according to claim 2 wherein said bulged portion is in said semi-circular perimeter.

4. A transmitting multi-row chain according to claim 1, comprising rollers rotatably mounted on said bushes.

5. A transmitting multi-row chain according to claim 1, wherein said bushes are hollow, said pin holes being in registry with said bushes, and said connecting pins passing through said hollow bushes.
